(19) United States
(12) Patent Application Publication
(10) Pub. No.: US 2026/0268581 A1
(43) Pub. Date: Sep. 10, 2026

(54) ARTIFICIAL INTELLIGENCE DEVICE FOR VIRTUAL MULTIVIEW GENERATION AND FUSION FRAMEWORK FOR SEMANTIC SCENE COMPLETION AND METHOD THEREOF

(71) Applicant: LG ELECTRONICS INC., Seoul (KR)

(72) Inventors: Anith SELVAKUMARASINGAM, Toronto (CA); Manasa BHARADWAJ, Toronto (CA)

(73) Assignee: LG ELECTRONICS INC., Seoul (KR)

(21) Appl. No.: 19/558,124

(22) Filed: Mar. 5, 2026

Related U.S. Application Data
(60) Provisional application No. 63/767,508, filed on Mar. 5, 2025.

(51) Int. Cl. G06T 15/08; G06T 3/067; G06T 7/50; G06T 7/70; G06T 7/80; G06T 15/20

(52) U.S. Cl. CPC G06T 15/08; G06T 3/067; G06T 7/50; G06T 7/70; G06T 7/80; G06T 15/20; G06T 2207/30244

(57) ABSTRACT

A method for controlling an artificial intelligence (AI) device can include receiving a single two-dimensional (2D) image of a scene captured from an initial viewpoint, determining a plurality of virtual camera poses spherically distributed around a centroid of the scene at predetermined angular offsets relative to the initial viewpoint, generating, by a novel view synthesis model, a plurality of synthesized 2D images corresponding to the plurality of virtual camera poses, processing, by a semantic scene completion model, the single 2D image and the plurality of synthesized 2D images to generate a plurality of corresponding three-dimensional (3D) scene predictions, and fusing, by a transformer-based multi-view fusion adaptor, the plurality of corresponding 3D scene predictions to generate a unified 3D semantic occupancy map. Also, the fusing can include applying a self-attention mechanism utilizing spatial positional encoding and view positional encoding to resolve structural ambiguities in occluded regions of the scene.

### CROSS-REFERENCE TO RELATED APPLICATIONS

This non-provisional application claims priority under 35 U.S.C. § 119 (e) to U.S. Provisional Application No. 63/767,508, filed on Mar. 5, 2025, the entirety of which is hereby expressly incorporated by reference into the present application.

### BACKGROUND

### Field

The present disclosure relates to a device and method for generating a three-dimensional (3D) semantic occupancy map from a single two-dimensional (2D) images, in the field of computer vision and artificial intelligence (AI). Particularly, the method can implement a framework (GenFuSE) that generates and leverages synthesized virtual viewpoints to resolve spatial occlusions to provide enhanced monocular semantic scene completion and improved 3D prediction certainty.

### Discussion of the Related Art

Artificial intelligence (AI) and computer vision have seen significant advancements, particularly with the development of robotic navigation systems and autonomous agents. These systems increasingly rely on various types of three-dimensional (3D) scene reconstruction models to understand and interact with their environments (e.g., by generating a 3D semantic occupancy map from two-dimensional (2D) sensor data). These 3D mapping models are increasingly being deployed to assist in a wide range of real world applications, from autonomous driving to indoor robotic navigation.

While the functional capabilities of these computer vision models have grown, their approach to 3D reconstruction from a single monocular image remains limited and prone to errors. For example, existing systems typically process a single 2D RGB image without access to multi-view geometric context or dedicated depth sensor data. Accordingly, the outputs are often plagued by severe depth, scale and shape ambiguities that fail to capture the true physical layout of the environment. These issues can lead to distorted representations and reduced overall spatial awareness.

Also, reliance on a single viewpoint is a significant limitation, particularly in complex indoor environments. For example, when tasked with mapping a cluttered room, a conventional scene reconstruction model may correctly identify visible surfaces but will be incapable of accurately reconstructing objects or features hidden behind obstacles (e.g., such as a piece of furniture occluded by an object). This forces the system to either leave these occluded regions as empty space or generate highly uncertain or distorted shapes.

Further challenges exist due to the absence of a robust, low-cost framework for overcoming these occlusions. Existing solutions to multi-view problems typically focus on hardware, requiring expensive sensor setups like LiDAR arrays or multi-camera rigs. While some recent software based approaches attempt to use generative AI to guess the missing information, these methods lack a systematic way to balance the introduction of novel, hallucinated structures with the preservation of accurate scene geometry. For instance, existing generative methods often introduce wild structural hallucinations and lack a reliable mechanism to quantify or enforce structural consistency when generating unseen portions of a physical space.

Thus, a need exists for an improved method and device that can enable computer vision models to execute accurate three-dimensional (3D) scene reconstruction from a single two-dimensional (2D) image in a robust manner that successfully resolves spatial occlusions and depth ambiguities without relying on expensive, multi-sensor hardware.

Furthermore, a need exists for a framework that can generate synthesized virtual viewpoints to reveal hidden structures while enforcing geometric fidelity. Such a method is needed to move beyond generic, unconstrained generative AI hallucinations and provide a robust, mathematically grounded solution that balances the introduction of novel scene information with structural consistency, in order to better ensure a highly accurate representation of the physical space.

Also, a need exists for a comprehensive framework that can systematically generate cohesive 3D semantic occupancy maps by leveraging coordinate transformations together with a generative synthesis model, and can intelligently resolve conflicting spatial predictions through an automated, transformer-based multi-view fusion to minimize 3D prediction uncertainty.

### SUMMARY OF THE DISCLOSURE

The present disclosure has been made in view of the above problems and it is an object of the present disclosure to provide a device and method that can provide improved three-dimensional (3D) scene reconstruction and semantic occupancy mapping from a single two-dimensional (2D) image. Further, the method can provide enhanced spatial accuracy by implementing a framework (GenFuSE) that generates and leverages synthesized virtual viewpoints to resolve geometric occlusions and intelligently fuses multiple spatial predictions to minimize overall 3D prediction uncertainty.

For example, since the method can include a generation component (Gen), a fusion component (Fu) and a semantic environment/scene estimation component (SE), it can be referred to by the acronym GenFuSE (e.g., Generative Fusion for Semantic Environments or (Scene Estimation)), but embodiments are not limited thereto.

An object of the present disclosure is to provide an artificial intelligence (AI) device and method for a three-dimensional (3D) scene reconstruction framework that can generate accurate semantic occupancy maps from a single image. The method can utilize a multi-component framework to systematically generate and fuse multi-view spatial predictions. For example, a coordinate transformation module can determine a plurality of virtual camera poses by performing spherical transformations around a scene centroid to enforce a novelty-consistency tradeoff. Then, a novel view synthesis model can process a single two-dimensional (2D) input image to synthesize novel viewpoints based on the virtual camera poses. Subsequently, a semantic scene completion model can process both the original 2D input image and the synthesized novel viewpoints to generate individual 3D scene predictions for each respective view. Further, a multi-view fusion adaptor, configured as a transformer-based architecture, can process the individual 3D scene predictions by applying spatial and view positional encodings to flattened voxel patches and utilizing a global self-attention mechanism to resolve semantic conflicts. This can produce a highly accurate, unified 3D semantic occupancy map that reveals hidden structures while maintaining geometric fidelity, while also minimizing 3D prediction uncertainty and enhancing overall spatial awareness.

Another object of the present disclosure is to provide a method for controlling an artificial intelligence (AI) device that can include receiving a single two-dimensional (2D) image of a scene captured from an initial viewpoint, determining a plurality of virtual camera poses spherically distributed around a centroid of the scene at predetermined angular offsets relative to the initial viewpoint, generating, by a novel view synthesis model, a plurality of synthesized 2D images corresponding to the plurality of virtual camera poses, processing, by a semantic scene completion model, the single 2D image and the plurality of synthesized 2D images to generate a plurality of corresponding three-dimensional (3D) scene predictions, and fusing, by a transformer-based multi-view fusion adaptor, the plurality of corresponding 3D scene predictions to generate a unified 3D semantic occupancy map, in which the fusing includes applying a self-attention mechanism utilizing spatial positional encoding and view positional encoding to resolve structural ambiguities in one or more occluded regions of the scene.

It is another object of the present disclosure to provide a method that further includes determining a mean-depth of the scene from the single 2D image using a monocular depth estimator neural network, in which the centroid of the scene is calculated based on the mean-depth.

Yet another object of the present disclosure is to provide a method, in which the determining the plurality of virtual camera poses includes calculating a relative pose transformation based on the predetermined angular offsets, and multiplying the relative pose transformation by an extrinsic camera matrix corresponding to the initial viewpoint.

An object of the present disclosure is to provide a method, in which the predetermined angular offsets are approximately +20 degrees relative to the initial viewpoint to optimize a tradeoff between informational novelty and geometric consistency.

Another object of the present disclosure is to provide a method, in which the processing by the semantic scene completion model includes extracting 2D features from the single 2D image and the plurality of synthesized 2D images, and geometrically projecting the 2D features into 3D volumetric spaces to output the plurality of corresponding 3D scene predictions as multi-channel class-probability voxel grids.

An object of the present disclosure is to provide a method in which the plurality of corresponding 3D scene predictions include 3D voxel grids, respectively, and the fusing the plurality of corresponding 3D scene predictions includes partitioning the 3D voxel grids into a plurality of 3D voxel patches, and flattening the plurality of 3D voxel patches into a sequence of one-dimensional (1D) tokens prior to applying the spatial positional encoding and the view positional encoding.

Yet another object of the present disclosure is to provide a method that further includes applying a linear transformation layer to the sequence of 1D tokens to project semantic channel probabilities into a higher-dimensional embedding space prior to applying the spatial positional encoding and the view positional encoding.

Another object of the present disclosure is to provide a method that further includes concatenating the sequence of 1D tokens corresponding to the initial viewpoint and the plurality of virtual camera poses into a single multi-view tensor to enable simultaneous global self-attention processing across all viewpoints.

An object of the present disclosure is to provide a method, in which the applying the spatial positional encoding and the view positional encoding includes performing an element-wise addition of a spatial coordinate representation and a camera viewpoint identifier to the sequence of 1D tokens to generate encoded embeddings.

Another object of the present disclosure is to provide a method, in which the applying the self-attention mechanism includes computing queries, keys, and values from an embedded representation of the plurality of corresponding 3D scene predictions using learned weight matrices, and calculating attention scores by applying a softmax function to dot products of the queries and the keys.

An object of the present disclosure is to provide a method, in which the self-attention mechanism is executed by a multi-head transformer encoder, and the fusing further includes concatenating outputs from multiple attention heads of the multi-head transformer encoder to generate concatenated outputs, and processing the concatenated outputs through a feed forward network includes fully connected linear layers separated by a non-linear activation function.

An object of the present disclosure is to provide a method, in which the fusing further includes applying a residual connection that bypasses the self-attention mechanism and applying a layer normalization operation to generate the unified 3D semantic occupancy map.

Another object of the present disclosure is to provide an artificial intelligence (AI) device including a memory configured to store information for information for a semantic scene completion model, and a controller configured to receive a single two-dimensional (2D) image of a scene captured from an initial viewpoint, determine a plurality of virtual camera poses spherically distributed around a centroid of the scene at predetermined angular offsets relative to the initial viewpoint, generate, by a novel view synthesis model, a plurality of synthesized 2D images corresponding to the plurality of virtual camera poses, process, by the semantic scene completion model, the single 2D image and the plurality of synthesized 2D images to generate a plurality of corresponding three-dimensional (3D) scene predictions, and fuse, by a transformer-based multi-view fusion adaptor, the plurality of corresponding 3D scene predictions to generate a unified 3D semantic occupancy map, in which the transformer-based multi-view fusion adaptor is configured to apply a self-attention mechanism utilizing spatial positional encoding and view positional encoding to resolve structural ambiguities in one or more occluded regions of the scene.

An object of the present disclosure is to provide a non-transitory computer readable medium storing computer-executable instructions that when executed by a processor, cause the processor to perform the operations of receiving a single two-dimensional (2D) image of a scene captured from an initial viewpoint, determining a plurality of virtual camera poses spherically distributed around a centroid of the scene at predetermined angular offsets relative to the initial viewpoint, generating, by a novel view synthesis model, a plurality of synthesized 2D images corresponding to the plurality of virtual camera poses, processing, by a semantic scene completion model, the single 2D image and the plurality of synthesized 2D images to generate a plurality of corresponding three-dimensional (3D) scene predictions, and fusing, by a transformer-based multi-view fusion adaptor, the plurality of corresponding 3D scene predictions to generate a unified 3D semantic occupancy map, in which the fusing includes applying a self-attention mechanism utilizing spatial positional encoding and view positional encoding to resolve structural ambiguities in one or more occluded regions of the scene.

In addition to the objects of the present disclosure as mentioned above, additional objects and features of the present disclosure will be clearly understood by those skilled in the art from the following description of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 illustrates an AI device according to an embodiment of the present disclosure.

FIG. 2 illustrates an AI server according to an embodiment of the present disclosure.

FIG. 3 illustrates an AI device according to an embodiment of the present disclosure.

FIG. 4 illustrates an example encoder-decoder based transformer architecture according to an embodiment of the present disclosure.

FIG. 5 illustrates an example flow chart for a method (GenFuSE) of controlling an AI device according to an embodiment of the present disclosure.

FIG. 6 is a flowchart illustrating an example overview of the GenFuSE framework, according to an embodiment of the present disclosure.

FIG. 7 illustrates the impact of occlusion on semantic scene completion (SSC) from a single view and the mitigation thereof through novel view synthesis according to an embodiment of the present disclosure.

FIG. 8A illustrates a high-level system diagram for generating context relevant virtual views to enhance 3D spatial predictions according to an embodiment of the present disclosure.

FIG. 8B illustrates a detailed system-level architecture of the GenFuSE framework, including a multi-view generation pipeline and a transformer-based multi-view fusion adaptor (MVFA), according to an embodiment of the present disclosure.

### DETAILED DESCRIPTION OF THE EMBODIMENTS

Reference will now be made in detail to the embodiments of the present disclosure, examples of which are illustrated in the accompanying drawings.

Wherever possible, the same reference numbers will be used throughout the drawings to refer to the same or like parts.

Advantages and features of the present disclosure, and implementation methods thereof will be clarified through following embodiments described with reference to the accompanying drawings.

The present disclosure can, however, be embodied in different forms and should not be construed as limited to the embodiments set forth herein.

Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details.

Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description. In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms.

These terms are only used to distinguish one element from another. For example, a first element could be termed a second element, and, similarly, a second element could be termed a first element, without departing from the scope of the present disclosure.

Further, “X-axis direction,” “Y-axis direction” and “Z-axis direction” should not be construed by a geometric relation only of a mutual vertical relation and can have broader directionality within the range that elements of the present disclosure can act functionally.

The term “at least one” should be understood as including any and all combinations of one or more of the associated listed items.

For example, the meaning of “at least one of a first item, a second item and a third item” denotes the combination of all items proposed from two or more of the first item, the second item and the third item as well as the first item, the second item or the third item.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship. Also, the term “can” used herein includes all meanings and definitions of the term “may.”

Hereinafter, the preferred embodiments of the present disclosure will be described in detail with reference to the accompanying drawings. All the components of each device or apparatus according to all embodiments of the present disclosure are operatively coupled and configured.

Artificial intelligence (AI) refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and can mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network can include an input layer, an output layer, and optionally one or more hidden layers. Each layer includes one or more neurons, and the artificial neural network can include a synapse that links neurons to neurons. In the artificial neural network, each neuron can output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network can be to determine the model parameters that minimize a loss function. The loss function can be used as an index to determine optimal model parameters in the learning process of the artificial neural network.

Machine learning can be classified into supervised learning, unsupervised learning, and reinforcement learning according to a learning method.

The supervised learning can refer to a method of learning an artificial neural network in a state in which a label for learning data is given, and the label can mean the correct answer (or result value) that the artificial neural network must infer when the learning data is input to the artificial neural network. The unsupervised learning can refer to a method of learning an artificial neural network in a state in which a label for learning data is not given. The reinforcement learning can refer to a learning method in which an agent defined in a certain environment learns to select a behavior or a behavior sequence that maximizes cumulative compensation in each state.

Machine learning, which can be implemented as a deep neural network (DNN) including a plurality of hidden layers among artificial neural networks, is also referred to as deep learning, and the deep learning is part of machine learning. In the following, machine learning is used to mean deep learning.

Self-driving refers to a technique of driving for oneself, and a self-driving vehicle refers to a vehicle that travels without an operation of a user or with a minimum operation of a user. For example, the self-driving can include a technology for maintaining a lane while driving, a technology for automatically adjusting a speed, such as adaptive cruise control, a technique for automatically traveling along a predetermined route, and a technology for automatically setting and traveling a route when a destination is set.

The vehicle can include a vehicle having only an internal combustion engine, a hybrid vehicle having an internal combustion engine and an electric motor together, and an electric vehicle having only an electric motor, and can include not only an automobile but also a train, a motorcycle, and the like.

Also, the self-driving vehicle can be regarded as a robot having a self-driving function.

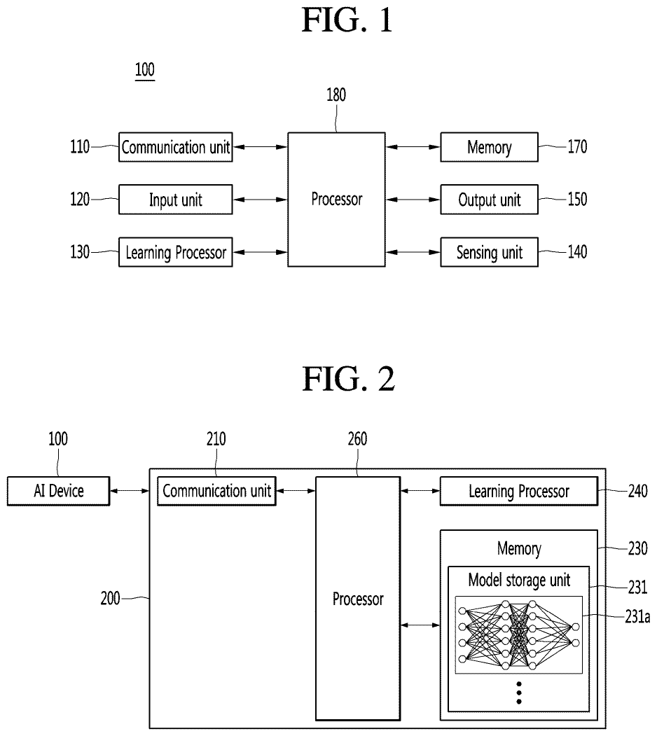

FIG. 1 illustrates an artificial intelligence (AI) device 100 according to one embodiment.

The AI device 100 can be implemented by a stationary device or a mobile device, such as a television (TV), a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like. However, other variations are possible.

Referring to FIG. 1, the AI device 100 can include a communication unit 110 (e.g., transceiver), an input unit 120 (e.g., touchscreen, keyboard, mouse, microphone, etc.), a learning processor 130, a sensing unit 140 (e.g., one or more sensors or one or more cameras), an output unit 150 (e.g., a display or speaker), a memory 170, and a processor 180 (e.g., a controller).

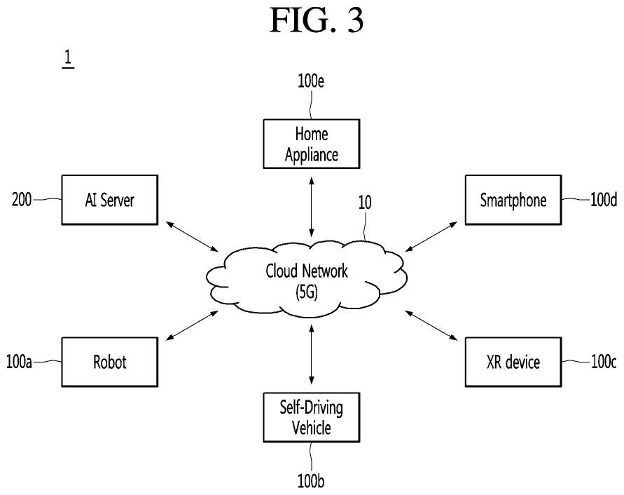

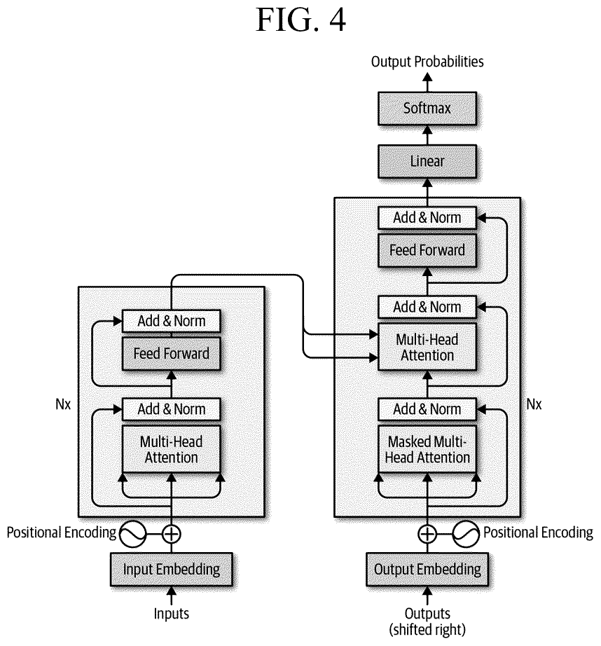

The communication unit 110 (e.g., communication interface or transceiver) can transmit and receive data to and from external devices such as other AI devices 100a to 100e and the AI server 200 (e.g., FIGS. 2 and 3) by using wire/wireless communication technology. For example, the communication unit 110 can transmit and receive sensor information, a user input, a learning model, and a control signal to and from external devices.

The communication technology used by the communication unit 110 can include GSM (Global System for Mobile communication), CDMA (Code Division Multi Access), LTE (Long Term Evolution), 5G, WLAN (Wireless LAN), Wi-Fi (Wireless-Fidelity), BLUETOOTH, RFID (Radio Frequency Identification), Infrared Data Association (IrDA), ZIGBEE, NFC (Near Field Communication), and the like.

The input unit 120 can acquire various kinds of data.

Also, the input unit 120 can include a camera for inputting a video signal, a microphone for receiving an audio signal, and a user input unit for receiving information from a user. The camera or the microphone can be treated as a sensor, and the signal acquired from the camera or the microphone can be referred to as sensing data or sensor information.

The input unit 120 can acquire learning data for model learning and input data to be used when an output is acquired by using a learning model. The input unit 120 can acquire raw input data. In this situation, the processor 180 or the learning processor 130 can extract an input feature by preprocessing the input data.

The learning processor 130 can learn a model composed of an artificial neural network by using learning data. The learned artificial neural network can be referred to as a learning model. The learning model can be used to infer a result value for new input data rather than learning data, and the inferred value can be used as a basis for determination to perform a certain operation.

For example, the learning processor 130 can perform AI processing together with the learning processor 240 of the AI server 200.

Also, the learning processor 130 can include a memory integrated or implemented in the AI device 100. Alternatively, the learning processor 130 can be implemented by using the memory 170, an external memory directly connected to the AI device 100, or a memory held in an external device.

The sensing unit 140 can acquire at least one of internal information about the AI device 100, ambient environment information about the AI device 100, and user information by using various sensors.

Examples of the sensors included in the sensing unit 140 can include a proximity sensor, an illuminance sensor, an acceleration sensor, a magnetic sensor, a gyro sensor, an inertial sensor, an RGB sensor, an IR (infrared) sensor, a fingerprint recognition sensor, an ultrasonic sensor, an optical sensor, a camera, a microphone, a lidar, and a radar.

The output unit 150 can generate an output related to a visual sense, an auditory sense, or a haptic sense.

Also, the output unit 150 can include a display unit for outputting time information, a speaker for outputting auditory information, and a haptic module for outputting haptic information.

The memory 170 can store data that supports various functions of the AI device 100. For example, the memory 170 can store input data acquired by the input unit 120, learning data, a learning model, a learning history, and the like.

The processor 180 can determine at least one executable operation of the AI device 100 based on information determined or generated by using a machine learning algorithm. The processor 180 can control the components of the AI device 100 to execute the determined operation. For example, the processor 180 can implement an AI model to generate output based on a plurality of modalities. Also, the generated output can be used by AI systems in various downstream related tasks other than text generate (e.g., object identification, control instructions to move a robot, control maneuvering for a self-driving vehicle, in game content generation, etc.).

To this end, the processor 180 can request, search, receive, or utilize data of the learning processor 130 or the memory 170. The processor 180 can control the components of the AI device 100 to execute the predicted operation or the operation determined to be desirable among the at least one executable operation.

When the connection of an external device is used to perform the determined operation, the processor 180 can generate a control signal for controlling the external device and can transmit the generated control signal to the external device.

The processor 180 can acquire information from the user input and produce an answer to a query, carry out an action or movement, or manipulate an object in the real world.

The processor 180 can acquire the information corresponding to the user input by using at least one of a speech to text (STT) engine for converting speech input into a text string or a natural language processing (NLP) engine for acquiring intention information of a natural language.

At least one of the STT engine or the NLP engine can be configured as an artificial neural network, at least part of which is learned according to the machine learning algorithm. At least one of the STT engine or the NLP engine can be learned by the learning processor 130, can be learned by the learning processor 240 of the AI server 200 (see FIG. 2), or can be learned by their distributed processing.

The processor 180 can collect history information including user profile information, the operation contents of the AI device 100 or the user's feedback on the operation and can store the collected history information in the memory 170 or the learning processor 130 or transmit the collected history information to the external device such as the AI server 200. The collected history information can be used to update the learning model.

The processor 180 can control at least part of the components of AI device 100 to drive an application program stored in memory 170. Furthermore, the processor 180 can operate two or more of the components included in the AI device 100 in combination to drive the application program.

FIG. 2 illustrates an AI server according to one embodiment.

Referring to FIG. 2, the AI server 200 can refer to a device that learns an artificial neural network by using a machine learning algorithm or uses a learned artificial neural network. The AI server 200 can include a plurality of servers to perform distributed processing, or can be defined as a 5G network, 6G network or other communications network. Also, the AI server 200 can be included as a partial configuration of the AI device 100, and can perform at least part of the AI processing together.

The AI server 200 can include a communication unit 210, a memory 230, a learning processor 240, a processor 260, and the like.

The communication unit 210 can transmit and receive data to and from an external device such as the AI device 100.

The memory 230 can include a model storage unit 231. The model storage unit 231 can store a learning or learned model (or an artificial neural network 231a) through the learning processor 240.

The learning processor 240 can learn the artificial neural network 231a by using the learning data. The learning model can be used in a state of being mounted on the AI server 200 of the artificial neural network, or can be used in a state of being mounted on an external device such as the AI device 100.

The AI model can be implemented in hardware, software, or a combination of hardware and software. If all or part of the learning models are implemented in software, one or more instructions that constitute the learning model can be stored in the memory 230.

The processor 260 can infer the result value for new input data by using the AI model and can generate a response or a control command based on the inferred result value.

FIG. 3 illustrates an AI system 1 including a terminal device according to one embodiment.

Referring to FIG. 3, in the AI system 1, at least one of an AI server 200, a robot 100a, a self-driving vehicle 100b, an XR (extended reality) device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, can be referred to as AI devices 100a to 100e. The AI server 200 of FIG. 3 can have the configuration of the AI server 200 of FIG. 2.

According to an embodiment, the method can be implemented as an interactive application or program that can be downloaded or installed in the smartphone 100d, which can communicate with the AI server 200, but embodiments are not limited thereto.

The cloud network 10 can refer to a network that forms part of a cloud computing infrastructure or exists in a cloud computing infrastructure. The cloud network 10 can be configured by using a 3G network, a 4G or LTE network, a 5G network, a 6G network, or other network.

For instance, the devices 100a to 100e and 200 configuring the AI system 1 can be connected to each other through the cloud network 10. In particular, each of the devices 100a to 100e and 200 can communicate with each other through a base station, but can directly communicate with each other without using a base station.

The AI server 200 can include a server that performs AI processing and a server that performs operations on big data. According to embodiments, the AI model can be fully implemented on an edge device (e.g., locally on devices 100a to 100e) or fully implemented AI server 200 in which an edge device collected the raw audio and video signals to provide to the AI server 200. According to another embodiment, parts of the AI model can be distributed across both of an edge device and the AI server 200.

The AI server 200 can be connected to at least one of the AI devices constituting the AI system 1, that is, the robot 100a, the self-driving vehicle 100b, the XR device 100c, the smartphone 100d, or the home appliance 100e through the cloud network 10, and can assist at least part of AI processing of the connected AI devices 100a to 100e.

In addition, the AI server 200 can learn the artificial neural network according to the machine learning algorithm instead of the AI devices 100a to 100e, and can directly store the learning model or transmit the AI model to the AI devices 100a to 100e.

Further, the AI server 200 can receive input data from the AI devices 100a to 100e, can infer the result value for the received input data by using the AI model, can generate a response or a control command based on the inferred result value, and can transmit the response or the control command to the AI devices 100a to 100e. Each AI device 100a to 100e can have the configuration of the AI device 100 of FIGS. 1 and 2 or other suitable configurations.

Alternatively, the AI devices 100a to 100e can infer the result value for the input data by directly using the learning model, and can generate the response or the control command based on the inference result.

Hereinafter, various embodiments of the AI devices 100a to 100e to which the above-described technology is applied will be described. The AI devices 100a to 100e illustrated in FIG. 3 can be regarded as a specific embodiment of the AI device 100 illustrated in FIG. 1.

According to an embodiment, the home appliance 100e can be a home robot, a drone, a smart television (TV), smart microwave, smart oven, smart washing machine or dryer, smart refrigerator or other display device, which can implement one or more of a large language model (LLM), a chat-bot, a digital avatar assistant, a shopping assistant or concierge, a question and answering system, etc. The method can be in the form of an executable application or program.

The robot 100a, to which the AI technology is applied, can be implemented as an entertainment robot, a guide robot, a carrying robot, a cleaning robot, a wearable robot, a pet robot, an unmanned flying robot, a home robot, a care robot or the like.

The robot 100a can include a robot control module for controlling the operation, and the robot control module can refer to a software module or a chip implementing the software module by hardware.

The robot 100a can acquire state information about the robot 100a by using sensor information acquired from various kinds of sensors, can detect (recognize) surrounding environment and objects, can generate map data, can determine the route and the travel plan, can determine the response to user interaction, or can determine the operation.

The robot 100a can use the sensor information acquired from at least one sensor among the lidar, the radar, and the camera to determine the travel route and the travel plan.

The robot 100a can perform the above-described operations by using the AI model composed of at least one artificial neural network. For example, the robot 100a can recognize the surrounding environment and the objects by using the AI model, and can determine the operation by using the recognized surrounding information or object information. The learning model can be learned directly from the robot 100a or can be learned from an external device such as the AI server 200.

Also, the robot 100a can perform the operation by generating the result by directly using the AI model, but the sensor information can be transmitted to the external device such as the AI server 200 and the generated result can be received to perform the operation.

The robot 100a can use at least one of the map data, the object information detected from the sensor information, or the object information acquired from the external apparatus to determine the travel route and the travel plan, and can control the driving unit such that the robot 100a travels along the determined travel route and travel plan. Further, the robot 100a can determine an action to pursue, manipulate an object, generate an output or an item to recommend. Also, the robot 100a can perform a real world action, generate an answer in response to a user query and the robot 100a can have animated facial expressions. The answer can be in the form of natural language.

The map data can include object identification information about various objects arranged in the space in which the robot 100a moves. For example, the map data can include object identification information about fixed objects such as walls and doors and movable objects such as desks. The object identification information can include a name, a type, a distance, and a position.

In addition, the robot 100a can perform the operation or travel by controlling the driving unit based on the control/interaction of the user. Also, the robot 100a can acquire the intention information of the interaction due to the user's operation or speech utterance, and can determine the response based on the acquired intention information, and can perform the operation while providing an animated face.

The robot 100a, to which the AI technology and the self-driving technology are applied, can be implemented as a guide robot, a carrying robot, a cleaning robot (e.g., an automated vacuum cleaner), a wearable robot, an entertainment robot, a pet robot, an unmanned flying robot (e.g., a drone or quadcopter), or the like.

The robot 100a, to which the AI technology and the self-driving technology are applied, can refer to the robot itself having the self-driving function or the robot 100a interacting with the self-driving vehicle 100b.

The robot 100a having the self-driving function can collectively refer to a device that moves for itself along the given movement line without the user's control or moves for itself by determining the movement line by itself.

The robot 100a and the self-driving vehicle 100b having the self-driving function can use a common sensing method to determine at least one of the travel route or the travel plan. For example, the robot 100a and the self-driving vehicle 100b having the self-driving function can determine at least one of the travel route or the travel plan by using the information sensed through the lidar, the radar, and the camera.

The robot 100a that interacts with the self-driving vehicle 100b exists separately from the self-driving vehicle 100b and can perform operations interworking with the self-driving function of the self-driving vehicle 100b or interworking with the user who rides on the self-driving vehicle 100b.

In addition, the robot 100a interacting with the self-driving vehicle 100b can control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b can monitor the user boarding the self-driving vehicle 100b and the user's emotional state, or can control the function of the self-driving vehicle 100b through the interaction with the user. For example, when it is determined that the driver is in a drowsy state or an angry state, the robot 100a can activate the self-driving function of the self-driving vehicle 100b or assist the control of the driving unit of the self-driving vehicle 100b. The function of the self-driving vehicle 100b controlled by the robot 100a can include not only the self-driving function but also the function provided by the navigation system or the audio system provided in the self-driving vehicle 100b.

Also, the robot 100a that interacts with the self-driving vehicle 100b can provide information or assist the function to the self-driving vehicle 100b outside the self-driving vehicle 100b. For example, the robot 100a can provide traffic information including signal information and the like, such as a smart signal, to the self-driving vehicle 100b, and automatically connect an electric charger to a charging port by interacting with the self-driving vehicle 100b like an automatic electric charger of an electric vehicle. Also, the robot 100a can perform chores and provide information and services to the user via a digital avatar, which can be personally tailored to the user based on the user's personal preferences.

According to an embodiment, the AI device 100 can provide a method for generating an accurate three-dimensional (3D) semantic occupancy map from a single two-dimensional (2D) image by synthesizing and leveraging virtual viewpoints within a multi-component framework to produce a unified 3D spatial representation that resolves geometric occlusions and minimizes spatial prediction uncertainty.

As discussed above, embodiments of the present disclosure relate to the field of artificial intelligence (AI), machine learning and computer vision, and more particularly, to methods and systems for generating accurate three-dimensional (3D) semantic occupancy maps from single two-dimensional (2D) images to enhance spatial awareness and minimize 3D prediction uncertainty.

For example, embodiments of the present disclosure can provide for a monocular 3D scene reconstruction framework for computer vision systems, which can be viewed as a foundational component for applications requiring robust spatial understanding and occlusion resolution from limited sensor data, such as autonomous driving systems, indoor robotic navigation, augmented and virtual reality (AR/VR) environment generation, and automated spatial planning.

As discussed above, the operational capabilities of computer vision models face several challenges that limit their practical utility and reliability in complex environments. While these semantic mapping models have become proficient at classifying visible pixels, their spatial perception is often superficial. The performance of these models in real-world 3D scenarios depends on their ability to accurately infer the surrounding geometric context and the complete structural layout of the environment.

One challenge is the lack of comprehensive multi-view geometric context. Related methods often operate on a strictly monocular basis, without a reliable mechanism to perceive depth or structure beyond the immediate line of sight. For example, a system might be tasked with mapping a living area. A conventional model may successfully generate a 3D representation of the visible walls and floor, but it will be unaware of the geometry and space occluded by a large object in the foreground, such as a large piece of furniture (e.g., a bed). This forces the system to leave the occluded areas as empty voids or heavily distorted shapes.

Another example of this limitation can be seen in robotic navigation or automated spatial planning scenarios. A system might be tasked with mapping a densely packed room, such as a kitchen or living room. A conventional model might correctly identify the open floor space in the immediate foreground. However, it would be incapable of accurately predicting the complex 3D structures and spatial footprint hidden behind bulky objects, such as tables or couches. The resulting generic 3D map could misrepresent the actual physical boundaries and navigable space of the room, making it unsuitable for safe, automated interaction without substantial multi-sensor hardware (e.g., extra sensors, such as LiDAR or Radar).

A further challenge in the existing art is the absence of a meaningful framework for enforcing structural consistency when attempting to artificially generate or guess these missing occluded regions.

Accordingly, a need exists for improved systems and methods that can provide improved generation of accurate three-dimensional (3D) semantic occupancy map from a single two-dimensional (2D) image that have enhanced spatial awareness and occlusion resolution while ensuring geometric consistency, and also reducing 3D prediction uncertainty and the need for expensive multi-sensor hardware.

According to an embodiment, the AI device 100 can provide a monocular three-dimensional (3D) scene reconstruction framework that overcomes the limitations of prior approaches. For example, a multi-component framework can be employed that utilizes one or more artificial intelligence models, in which different components are configured to perform specialized tasks. The framework can include a coordinate transformation module to systematically generate virtual camera poses, a novel view synthesis model and a semantic scene completion module to generate individual 3D spatial predictions for occluded regions, and a multi-view fusion adaptor with a transformer-based framework to quantitatively evaluate and fuse the spatial predictions by resolving semantic conflicts, thereby ensuring a superior and geometrically accurate output.

A transformer-based framework can offer many advantages. For example, a transformer neural network architecture can be used to implement various components of the framework, such as the multi-view fusion adaptor. In this way, the multi-view fusion adaptor can be configured to understand complex spatial dependencies and process sequences of embedding vectors, which enables the framework to interpret nuanced structural data across multiple viewpoints using global self-attention mechanisms and provide a cohesive, unified 3D representation.

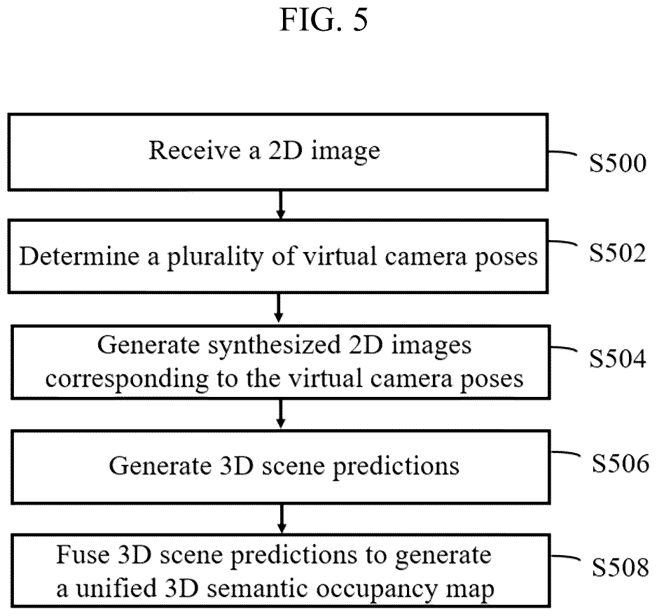

FIG. 4 illustrates an example encoder-decoder based transformer architecture that can be utilized by the multi-view fusion adaptor according to an embodiment of the present disclosure. For example, the framework can leverage one or more transformer-based neural networks to process multi-view spatial data.

According to an embodiment, the transformer architecture can include an encoder portion and a decoder portion, and employ global self-attention mechanisms. These attention mechanisms can allow the neural network to weigh the relative importance of different parts of an input sequence. In the context of spatial processing, this can enable the model to effectively capture long range geometric dependencies and structural relationships across varying viewpoints.

According to an embodiment, the transformer-based multi-view fusion adaptor can undergo its own pre-training phase, in which the model is trained on a massive and diverse amount of 3D structural data and multi-view representations. During this unsupervised or self-supervised learning stage, the model can learn fundamental spatial patterns, geometric structures, object permanence, and even spatial reasoning capabilities (e.g., predicting masked volumetric regions or the next sequence of spatial tokens).

According to an embodiment, the multi-view fusion adaptor can be subject to a fine-tuning phase. Fine-tuning can involve further training the pre-trained model on smaller, more specialized datasets tailored to specific tasks (e.g., indoor scene reconstruction, complex occlusion resolution, or specific domain geometries) or to align the model's behavior with desired characteristics, such as improved structural consistency across synthesized views.

For example, the multi-view fusion adaptor can operate by receiving spatial inputs, such as individual three-dimensional (3D) scene predictions that have been partitioned and translated into a sequence of embedding vectors or tokens. The transformer architecture can process these encoded sequences through its self-attention layers to resolve structural conflicts and generate a unified, contextually accurate output, such as a cohesive 3D semantic occupancy map. The multi-view fusion adaptor is discussed in more detail at a later section.

According to an embodiment, the multi-phase architecture and method described herein can be referred to as the GenFuSE framework. The term GenFuSE can refer to a Generative Fusion for Semantic Environments (or Semantic Estimation) architecture. For example, the “Gen” aspect can correspond to the generative artificial intelligence utilized in the novel view synthesis (NVS) module to generate the synthesized 2D images. The “Fu” aspect can correspond to the multi-view fusion adaptor (MVFA) that mathematically fuses the multiple individual 3D scene predictions. Also, the “SE” aspect can correspond to the output and purpose of the system, which is 3D semantic scene completion or semantic environment estimation. However, embodiments are not limited thereto.

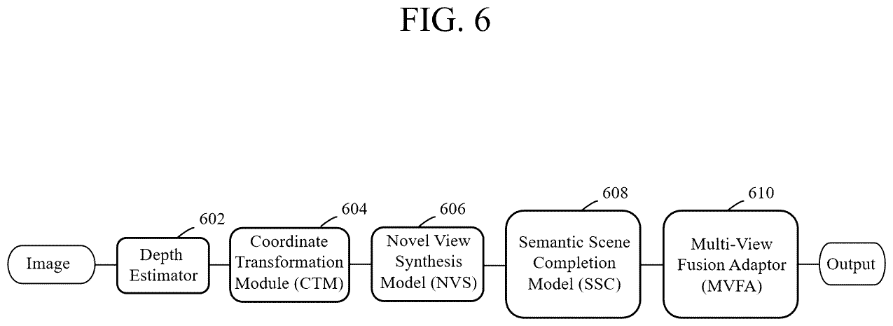

FIG. 5 shows an example flow chart of a method (GenFuSE) according to an embodiment of the present disclosure.

For example, according to an embodiment, a method for controlling an AI device 100 can include receiving a 2D image of a scene captured from an initial viewpoint (S500).

According to an embodiment, prior to determining virtual camera poses, the processor can determine a mean-depth of the scene from the single 2D image using a monocular depth estimator neural network. In this way, a centroid of the scene can be dynamically calculated based on the determined mean-depth to serve as a rotational anchor point. However, embodiments are not limited thereto and the mean-depth information can be predetermined or provided by an external device.

At S502, the method can include determining, by the processor, a plurality of virtual camera poses spherically distributed around the centroid of the scene at predetermined angular offsets relative to the initial viewpoint.

According to an embodiment, determining the plurality of virtual camera poses at step S502 can include calculating a relative pose transformation based on the predetermined angular offsets, and multiplying the relative pose transformation by an extrinsic camera matrix corresponding to the initial viewpoint.

For example, the predetermined angular offsets can be approximately +20 degrees relative to the initial viewpoint to optimally balance informational novelty and geometric consistency.

At S504, the method can include generating synthesized 2D images corresponding to the virtual camera poses, which can be performed by a novel view synthesis model.

At S506, the method can include generating 3D scene predictions, performed by a semantic scene completion model processing the single 2D image and the plurality of synthesized 2D images.

According to an embodiment, generating 3D scene predictions at step S506 can include extracting 2D features from the single 2D image and the plurality of synthesized 2D images, and geometrically projecting the extracted 2D features into 3D volumetric spaces to output the 3D scene predictions as multi-channel class-probability voxel grids.

At S508, the method can include fusing 3D scene predictions to generate a unified 3D semantic occupancy map. This step can be performed by a transformer-based multi-view fusion adaptor.

According to an embodiment, the fusing at step S508 can include applying a self-attention mechanism utilizing spatial positional encoding and view positional encoding to resolve structural ambiguities in one or more occluded regions of the scene.

According to an embodiment, to prepare the data for the self-attention mechanism during the fusing step S508, the fusing can further include partitioning the 3D voxel grids into a plurality of 3D voxel patches and flattening the plurality of 3D voxel patches into a sequence of one-dimensional (1D) tokens.

Also, a linear transformation layer can be applied to the sequence of 1D tokens to project semantic channel probabilities into a higher-dimensional embedding space. The sequence of 1D tokens corresponding to the initial viewpoint and the plurality of virtual camera poses can then be concatenated into a single multi-view tensor to enable simultaneous global self-attention processing across all viewpoints.

The spatial positional encoding and the view positional encoding can be applied by performing an element-wise addition of a spatial coordinate representation and a camera viewpoint identifier to the sequence of 1D tokens to generate fully encoded embeddings.

Furthermore, according to an embodiment, the fusing at step S508 can include applying a residual connection that bypasses the self-attention mechanism and applying a layer normalization operation to generate the unified 3D semantic occupancy map.

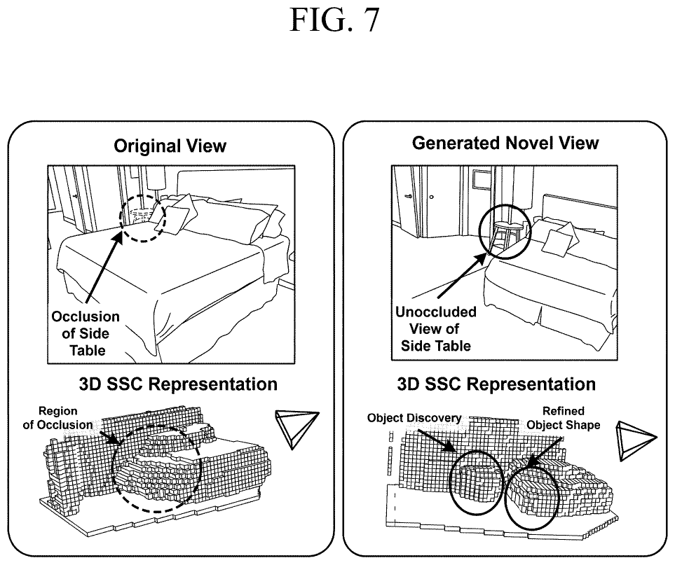

FIG. 6 illustrates a block diagram of an example of the GenFuSE framework, according to an embodiment of the present disclosure. For example, according to an embodiment, the AI model can be implemented as a cohesive architecture of interconnected modules designed to implement the multi-phase workflow previously described.

As shown in the FIG. 6, the GenFuSE framework can include a depth estimator 602, a coordinate transformation module (CTM) 604, a novel view synthesis model (NVS) 606, a semantic scene completion model (SSC) 608, and a multi-view fusion adaptor (MVFA) 610.

For example, the GenFuSE framework can include two main modules or two main parts, in which the first module can be referred to as a virtual multi-view scene generation pipeline that includes the depth estimate 602, the CTM 604, the NVS 606 and the SSC 608, and the second module includes the multi-view fusion adaptor (MVFA) 610.

According to an embodiment, the framework can begin processing at the depth estimator 602, which can be configured as an artificial intelligence (AI) based deep neural depth network. The depth estimator 602 can receive a single two-dimensional (2D) RGB image (e.g., a picture of a room or indoor space) as an input.

Internally, the depth estimator 602 can operate as a monocular depth estimator neural network that analyzes the 2D image to predict the physical distance of surfaces within the scene. The depth estimator 602 can average these predicted distances to calculate and output a 3D mean-depth centroid of the room or physical space.

Following the depth estimation, the coordinate transformation module (CTM) 604 can receive the calculated mean-depth centroid along with an initial camera pose as inputs. According to an embodiment, the coordinate transformation module (CTM) 604 can operate using deterministic math and programming logic.

For example, the coordinate transformation module (CTM) 604 can function as a math engine that applies spherical coordinates (e.g., r, θ, φ) to calculate systematic rotations around the 3D centroid. Based on these geometric calculations, the coordinate transformation module (CTM) 604 can output a plurality of virtual camera poses, which can be formatted as extrinsic camera matrices.

Next, the novel view synthesis model (NVS) 606 can receive the original single 2D RGB image and the generated virtual camera poses from the coordinate transformation module (CTM) 604 as inputs. The novel view synthesis model (NVS) 606 can be configured as an AI-based module that utilizes diffusion-based generative AI.

Internally, the novel view synthesis model (NVS) 606 can start with a frame or image of random noise (e.g., static) and apply a progressive denoising process conditioned on the original image and the precise virtual camera poses. As a result of this generative process, the novel view synthesis model (NVS) 606 can output a set of synthesized 2D images that accurately depict the scene from the new, virtual angles.

For example, the denoising process can be based on diffusion and can include starting with an image of just static noise and then iterate through a predetermined sequence of denoising steps. At each step, a neural network within the novel view synthesis model (NVS) 606 can calculate and subtracts a predicted fraction of the noise. To ensure the generated output is physically accurate rather than a random hallucination, this noise prediction can be conditioned on both the visual features extracted from the original 2D image and the specific geometric coordinates of the virtual camera pose.

As the model iteratively removes the noise over successive passes, the unstructured static progressively resolves into a high-fidelity, coherent 2D image that accurately depicts the target scene from the synthesized viewpoint. The diffusion process can be based on a latent diffusion framework (e.g., Stable Diffusion), but embodiments are not limited thereto.

Further in this example, the semantic scene completion model (SSC) 608 can then process both the original 2D image and the synthesized 2D images, along with their corresponding camera poses, as inputs. The semantic scene completion model (SSC) 608 can be configured as an AI-based deep learning module that utilizes a monocular SSC backbone neural network.

According to an embodiment, this backbone can be model-agnostic, but embodiments are not limited thereto. The semantic scene completion model (SSC) 608 functions as a computer vision network configured to extract 2D features from the images and geometrically project them into 3D volumetric spaces.

The semantic scene completion model (SSC) 608 can output individual 3D scene predictions for each respective view, which can be structured as class-probability voxel grids having dimensions of C×H×W×D.

For example, a voxel is a three-dimensional (3D) volume element that represents a single, discrete data point on a regular volumetric grid in 3D space. Just as a pixel can represent a tiny square of two-dimensional (2D) area in a standard flat digital image, a voxel can represent a specific, bounded 3D cube or block of physical space within the reconstructed environment.

According to an embodiment, each individual voxel within the C×H×W×D voxel grid can act as a spatial container configured to store data about that precise physical location. In the context of the semantic scene completion model (SSC) 608, each voxel can hold multi-channel class-probability distribution data indicating the mathematical likelihood that its corresponding physical space is empty, solid, or belongs to a specific semantic object class (e.g., such as a wall, a piece of furniture, or an occluded region).

Further in this example, the multi-view fusion adaptor (MVFA) 610 can receive all of the individual 3D scene predictions output by the semantic scene completion model (SSC) 608 as inputs. The multi-view fusion adaptor (MVFA) 610 can be configured as an AI-based module built upon a transformer neural network architecture.

To process the inputs, the multi-view fusion adaptor (MVFA) 610 can partition the 3D voxel grids into smaller voxel patches and flatten them into 1D embedding vectors, which can be referred to as tokens.

The multi-view fusion adaptor (MVFA) 610 can then add spatial positional encodings (SPE) and view positional encodings (VPE) to the vectors and apply a global self-attention mechanism to intelligently resolve semantic conflicts between the different viewpoint predictions. Through this transformer-based fusion process, the multi-view fusion adaptor (MVFA) 610 can generate and outputs a single, unified 3D scene prediction occupancy map.

The single, unified 3D scene prediction occupancy map can be used in various downstream tasks, such as autonomous robotic navigation, path planning and collision avoidance, augmented and virtual reality (AR/VR) environment generation, and automated spatial or architectural analysis.

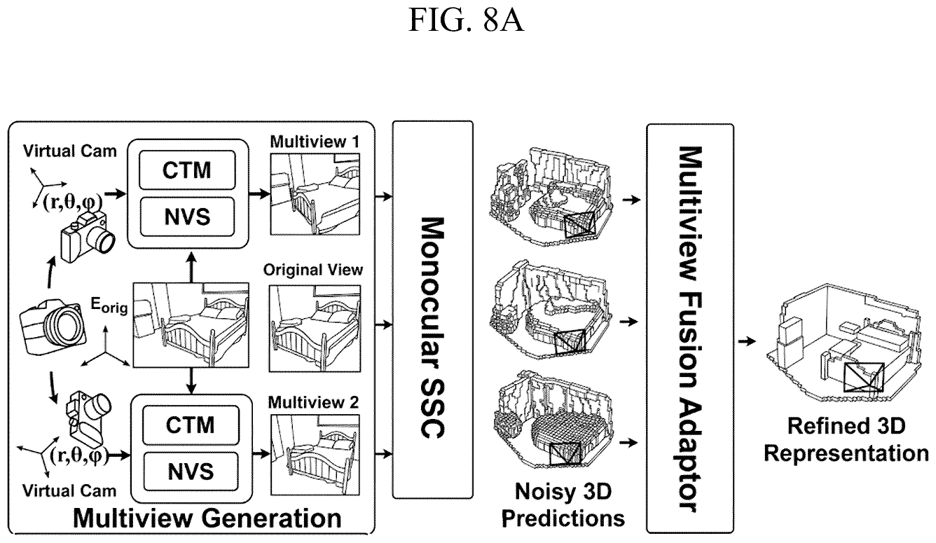

FIG. 7 illustrates an example of the impact of occlusion on semantic scene completion (SSC) from a single original view, as depicted in the left panel, and the mitigation of such occlusions through novel view synthesis, as depicted in the right panel, according to an embodiment.

As shown in the original view, structural elements of an environment, such as a side table, can be hidden behind foreground objects like a bed, resulting in a direct occlusion of the side table. Consequently, the corresponding 3D SSC representation generated solely from this single perspective suffers from a large region of occlusion, leaving the system unable to accurately predict the hidden physical geometry.

Conversely, the right panel of FIG. 7 demonstrates how the GenFuSE framework can resolve this spatial uncertainty. By synthesizing a generated novel view from a different angular perspective, the system can achieve direct line-of-sight access to the previously occluded regions.

For example, the generated novel view can secure an unobstructed view of the side table. When this synthesized visual data is fused into the pipeline, the resulting 3D SSC representation exhibits enhanced object discovery, successfully reconstructing the voxels for the hidden side table. Furthermore, the novel perspective provides additional geometric context that significantly refines the 3D shape representations of the existing objects (e.g., the side table, the bed), resulting in a more complete and highly accurate volumetric map of the scene.

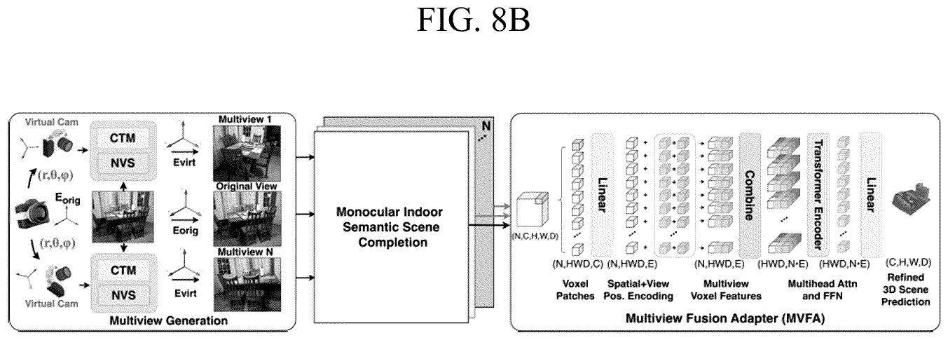

FIGS. 8A and 8B illustrate a system-level diagram of the GenFuSE framework according to an embodiment, in which a multi-view generation pipeline synthesizes additional views that are passed through a semantic scene completion (SSC) pipeline for individual prediction and subsequently fused by a multi-view fusion adaptor (MVFA) into a refined 3D representation.

For example, FIG. 8A shows a high-level diagram and the techniques used to generate context relevant views that enhance predictions and reduce uncertainty of predictions of occluded regions, according to an embodiment. Also, FIG. 8B shows a system level diagram of GenFuSE in more detail, according to an embodiment.

To mitigate the hardware constraints, computational overhead and costs associated with deploying multiple physical cameras or complex multi-sensor arrays (e.g., LiDAR or stereo-camera rigs), the pipeline can advantageously leverage synthesized virtual cameras strategically placed at different viewpoints.

For example, rather than relying on moving around actual hardware, spherical transformations calculated around a determined scene center can be utilized to strictly constrain the placement of these virtual cameras. This geometric constraint can guarantee that all generated synthetic views maintain the target scene within the active field of view of the virtual camera, preventing the generative models from rendering irrelevant, off-target background spaces or hallucinating ungrounded features.

According to an embodiment, this controlled virtual placement of the cameras is achieved through the coordinate transformation module (CTM) operating in conjunction with the novel view synthesis (NVS) module. However, embodiments are not limited thereto. For example, the virtual placement of the cameras can be set at predetermined locations, according to an embodiment.

For example, as shown in FIG. 8B, the coordinate transformation module (CTM) can be configured to act as a deterministic mathematical engine configured to translate standard spherical rotations into explicit camera poses that are formatted appropriately for processing by both the novel view synthesis (NVS) module and the semantic scene completion (SSC) module. The coordinate transformation module (CTM) can execute the following mathematical transformation, according to Equation 1 below.

$$CTM ( r , θ , ψ ) \to ( {E}_{rel} , {E}_{virt} ) \qquad [ Equation 1 ]$$

In the transformation above, the variable r represents the radius of the spherical rotation, which correlates to the mean-depth of the targeted scene. According to an embodiment, this mean-depth r can be dynamically computed from the single original 2D input image by a deep neural depth network (e.g., a monocular depth estimator).

Further, the variables θ and ψ represent the polar and azimuthal angles, respectively, defining the specific angular offset from the original physical viewpoint along the spherical orbit.

For example, the azimuthal angle ψ can be viewed as the left-to-right movement for placing the virtual camera (e.g., similar to moving along a longitude line on a globe), and the polar angle θ can be viewed as the up-and-down movement of the virtual camera (e.g., similar to moving along a latitude line on a globe).

In other words, the spherical orbit means keeping the camera the exact same distance away from the object (e.g., center of the room or indoor space) while moving it around. The two angles θ and y are the coordinates that tell the system exactly how far left/right and how far up/down to slide the virtual camera away from the real camera's original starting point.

Further in this example with reference to FIG. 8B, the coordinate transformation module (CTM) is configured to compute the relative camera pose, mathematically represented as Eᵣₑₗ. This calculation can be performed by executing a spherical rotation of the original physical camera's spatial coordinates around the calculated mean-depth centroid of the scene.

Also, to ensure the newly generated view remains perfectly focused on the target area, this initial spherical rotation is followed by a local rotation transformation that re-orients the virtual camera's trajectory to point directly back towards the 3D centroid. Once calculated, this highly accurate relative pose Eᵣₑₗ is input into the novel view synthesis (NVS) module to condition the generative diffusion process for novel view generation, thereby ensuring the artificially synthesized images are strictly grounded in accurate physical geometry.

Subsequently, the camera pose of the synthesized novel view, mathematically aligned to the world coordinate system of the original physical camera, can be derived by the coordinate transformation module (CTM) as follows according to Equation 2 below.

$${E}_{virt} = {E}_{rel} \cdot {E}_{orig} \qquad [ Equation 2 ]$$

In this Equation 2, E_{orig} represents the extrinsic camera matrix of the original physical viewpoint, Eᵣₑₗ represents the calculated relative pose transformation, and Eᵥᵢᵣₜ represents the resulting virtual camera pose. By multiplying the relative transformation matrix by the original camera matrix, the system can accurately anchor the virtual viewpoint within the real-world spatial geometry.

By maintaining these controlled spherical transformations around a fixed, dynamically calculated scene reference (e.g., the mean-depth centroid), the AI device 100 configured with the method can ensure strict scene-centric transformations regardless of the original camera's initial placement. This geometric constraint guarantees robustness across diverse physical camera configurations and allows the system to scale accurately across all scene types.

For example, the same mathematical transformations can be robustly applied whether the target scene is a cluttered indoor environment or a large, open architectural space, ensuring the virtual cameras always remain focused on the relevant structural features rather than drifting into empty background space.

Once the novel views are generated, the resulting synthesized scene image and its corresponding virtual camera pose, Eᵥᵢᵣₜ, are passed as inputs into the semantic scene completion (SSC) model. The semantic scene completion (SSC) model can process these inputs to generate a discrete volumetric prediction for that specific viewpoint. Mathematically, the 3D class-probability distribution output of the SSC module for any given view, denoted as i, can be represented as Pᵢ. The AI device 100 can be configured with the SSC model.

According to an embodiment, this output prediction Pᵢ can be structured as a multi-dimensional tensor or voxel grid having dimensions of C×H×W×D, where C represents the number of semantic classes (e.g., wall, floor, furniture, occluded/empty space), and H, W, and D represent the height, width, and depth dimensions of the 3D spatial grid, respectively.

Then, the complete collection of these individual 3D predictions (e.g., P₁, P₂, . . . , Pₙ) generated from the original and virtual views can be passed into the multi-view fusion adaptor (MVFA) for multi-view fusion and semantic conflict resolution.

According to an embodiment, the multi-view fusion adaptor (MVFA) can utilize a transformer-based neural network architecture configured for fusing multiple volumetric predictions in 3D semantic scene completion. The AI device 100 configured with the MVFA.

With reference again to FIG. 8B, the multi-view fusion adaptor (MVFA) can intelligently aggregate and fuse a plurality of individual 3D scene predictions (e.g., generated by the SSC module) into a single, refined 3D representation. For example, if a prediction from a virtual camera identifies a hidden structural element (e.g., like a night stand behind a bed) while the prediction from the original camera view leaves that space mainly empty due to visual occlusion, the multi-view fusion adaptor (MVFA) can intelligently resolve this spatial conflict to include the night stand in the final geometric map.

Given the aforementioned definition of an individual 3D class-probability distribution output, P, for a given view i, the overall mathematical function of the MVFA can be defined according to Equation 3 below.

$$MVFA : \{ {P}_{1} , {P}_{2} , … , {P}_{N} \} \to P , where P ∈ {R}^{C \times H \times W \times D} \qquad [ Equation 3 ]$$

In Equation 3, N represents the total number of viewpoints (e.g., both original and synthesized) being processed, and P represents the final, unified 3D semantic occupancy map. The resulting unified map P belongs to the coordinate space defined by P∈R^{C×H×WλD}.

For example, R denotes the set of real numbers, C represents the number of semantic classes, and H, W, and D represent the spatial dimensions (height, width, and depth) of the resulting 3D voxel grid.

Further, to process these predictions through a transformer architecture, the discrete semantic channel probabilities Pᵢ are mathematically projected into a higher-dimensional embedding space. The multi-view fusion adaptor (MVFA) can achieve this by applying a linear transformation layer to map the semantic probabilities into an embedding space of dimension E.

For example, this step can translate the raw probability scores into rich embedding vectors (or “tokens”) that the transformer's self-attention mechanisms can effectively analyze. This transformation can be represented according to Equation 4 below.

$${X}_{i} = Linear ( {P}_{i} ) , {X}_{i} ∈ {R}^{H \times W \times D \times E} \qquad [ Equation 4 ]$$

Then, once the predictions from all N views have been individually transformed into these high-dimensional embedding representations Xᵢ, the multi-view fusion adaptor (MVFA) can concatenate them together into a single, comprehensive multi-view tensor. This stacking operation prepares the complete dataset for global self-attention processing across all views simultaneously, and can be defined according to Equation 5 below.

$$X = Stack ( {X}_{1} , … , {X}_{N} ) , X ∈ {R}^{N \times H \times W \times D \times E} \qquad [ Equation 5 ]$$

In other words, to process the individual 3D scene predictions through its transformer architecture, the multi-view fusion adaptor (MVFA) of the AI device 100 can first convert the structured 3D spatial data into a format compatible with self-attention mechanisms by creating flattened voxel patches.

For instance, the MVFA can take the initial 3D class-probability distribution outputs (e.g., formatted as 3D voxel grids having H×W×D dimensions) and partitions them into smaller, 3D sub-volumes referred to as voxel patches. Because the transformer uses a one-dimensional (1D) sequence of inputs, each of these individual 3D voxel patches is mathematically flattened or reshaped into a single 1D array.

The multi-view fusion adaptor (MVFA) can then apply a linear transformation layer to project these flattened arrays into a higher-dimensional embedding space (E), translating the probabilities into a sequence of rich, 1D representation vectors or tokens (Xᵢ) that can be concatenated into a multi-view tensor and analyzed to intelligently resolve spatial conflicts, such as revealing a nightstand hidden behind a bed.

In more detail, to support the sequential input formatting used by the transformer architecture, the multi-dimensional tensor is reshaped into a one-dimensional (1D) sequence of tokens. For example, the five-dimensional representation (e.g., denoted as having dimensions (N, H, W, D, E) is flattened across its spatial dimensions into a linear sequence of H×W×D patches for each respective view. This flattening process transforms the volumetric grid of embeddings into a linear array that the global self-attention mechanisms of the transformer can process sequentially.

However, flattening this 3D spatial data into a 1D sequence can strip away geometric and source context. To retain this context during the multi-view fusion process, the multi-view fusion adaptor (MVFA) can use two distinct types of learned embeddings: (i) a spatial positional encoding (SPE) and (ii) a view positional encoding (VPE), which are applied to the flattened tokens according to Equations 6 and 7 described below.

$${SPE}_{x , y , z} = [ sin ( \frac{x}{{10000}^{\frac{2 k}{d}}} ) , cos ( \frac{x}{{10000}^{\frac{2 k + 1}{d}}} ) , sin ( \frac{y}{{10000}^{\frac{2 k}{d}}} ) , cos ( \frac{y}{{10000}^{\frac{2 k + 1}{d}}} ) , sin ( \frac{z}{{10000}^{\frac{2 k}{d}}} ) , cos ( \frac{z}{{10000}^{\frac{2 k + 1}{d}}} ) ] \qquad [ Equation 6 ]$$

$${VPE}_{i} = [ sin ( \frac{i}{{10000}^{\frac{2 k}{d}}} ) , cos ( \frac{i}{{10000}^{\frac{2 k + 1}{d}}} ) ] \qquad [ Equation 7 ]$$

$$where i = 0 , 1 , 2 , … , N - 1 , x , y , z ∈ ℤ ,$$

$$k = 0 , 1 , 2 , … , \frac{E}{2} - 1$$

According to an embodiment, once the spatial positional encoding (SPE) and view positional encoding (VPE) are generated, these encodings can be directly added to the high-dimensional embedding representation X. For example, this element-wise addition creates a spatially and multi-view encoded embedding, denoted as X′, which is calculated according to Equation (8) below.

$${X}_{i , h , w , d}^{′} = {X}_{i , h , w , d} + {SPE}_{h , w , d} + {VPE}_{i} \qquad [ Equation 8 ]$$

In Equation 8, the indices h, w, and d represent the spatial coordinates (height, width, and depth) of the 3D voxel patch within the overall grid, while the index i represents the specific camera viewpoint (e.g., the original physical camera or a specific virtual camera) from which that patch was generated. By summing these values, the resulting encoded embedding X′ includes both the structural data and its precise geometric and view-source context.

Then, this fully encoded embedding X′ can be reshaped into a sequence of (H×W×D) individual patches. To ensure the transformer can analyze all viewpoints for a given spatial location simultaneously, each patch is structured to have a dimension of N·E, where N is the total number of views and E is the embedding dimension. These reshaped, context rich patches are then sequentially fed as input into a multi-head transformer encoder.

Further in this example, as shown in FIG. 8B, the multi-head Transformer encoder utilizes a global self-attention mechanism to intelligently fuse the multiple views. For example, by leveraging both the spatial and multi-view context embedded in X′, the self-attention mechanism can compare a occluded patch from the original camera view against a clear patch from a virtual camera view covering the same 3D coordinates, allowing the network to prioritize the clearer structural data.

For instance, to perform this self-attention process, the transformer encoder can compute a set of queries (Q), keys (K), and values (V) from the input X′ using learned weight matrices. This computation can be defined according to Equation (9) below.

$$Q = {X}^{′} {W}_{Q} , K = {X}^{′} {W}_{K} , V = {X}^{′} {W}_{V} \qquad [ Equation 9 ]$$

In Equation 9, W_{Q}, W_{K}, and W_{V} represent learnable parameter weight matrices that are optimized during the neural network's training phase. For example, for any given patch, the query (Q) represents the structural information the network is looking for, the key (K) represents the spatial and view profile that the patch contains, and the value (V) represents the actual semantic data to be extracted if a match is found.

Further, by using h separate attention heads and defining d_{embed} as the total embedding dimension, the model can simultaneously project these queries, keys, and values into multiple different representation subspaces.

In this way, different attention heads can focus on different structural relationships simultaneously. For example, one attention head might specialize in resolving semantic conflicts at the boundaries of large objects, while another head can focus on identifying small, hidden structures.

Continuing with the multi-head self-attention process, the individual feature outputs from each of the h attention heads are concatenated together to form a single, comprehensive representation. This combined multi-head attention output can then be mathematically expressed according to Equation 10 below.

$$MultiHeadOutput = Concat ( {Attn}_{1} , … , {Attn}_{h} ) {W}_{O} \qquad [ Equation 10 ]$$

In Equation 10, W_{O} represents a learnable weight matrix that is configured to linearly project the concatenated multi-head attention outputs back into the original embedding space dimension.

Further, each individual attention head, denoted as Attnᵢ, can compute its attention scores using a scaled dot-product attention mechanism. While calculating this attention, a softmax function is applied to the dot products of the queries and keys to determine the relative probabilistic weights of the values. This individual attention calculation can be expressed according to Equation 11 below.

$${Attn}_{i} = softmax ( \frac{{Q}_{i} {K}_{i}^{T}}{\sqrt{{d}_{embed} / h}} ) {V}_{i} , i = 1 , 2 , … , h \qquad [ Equation 11 ]$$

Further in this example, to stabilize the neural network's learning process and prevent a vanishing gradient problem, a residual connection and a layer normalization operation can be performed on the multi-head output. For instance, the original encoded embedding input X′ can be bypassed around the attention sub-layer and added directly to the MultiHeadOutput, after which the sum is normalized. This intermediate fused state, denoted as Attn_{final}, can be calculated according to Equation 12 below.

$${Attn}_{final} = LayerNorm ( MultiHeadOutput + {X}^{′} ) \qquad [ Equation 12 ]$$

The Attn_{final} representation can then be passed through a feed forward network (FFN). The FFN can include fully connected linear layers separated by a non-linear activation function (e.g., such as a ReLU or GELU activation), which can further process the attended spatial features. This operation is represented in Equation 13 below.

$$FFNOutput = Linear ( {Attn}_{final} ) \qquad [ Equation 13 ]$$

Following the FFN, an additional residual connection and layer normalization step can be applied to mathematically finalize the fusion process and produce the final spatial representation P, as shown in Equation 14 below.

$$P = LayerNorm ( FFNOutput + {Attn}_{final} ) \qquad [ Equation 14 ]$$

As previously defined, this final output P belongs to the coordinate space R^{C×H×W×D}, representing the completed, unified 3D semantic occupancy map.

In this way, by leveraging the self-attention mechanism of the transformer architecture, the multi-view fusion adaptor (MVFA) can advantageously operate with a global receptive field. Unlike traditional convolutional neural networks (CNNs) that are limited to analyzing small, local spatial neighborhoods, this global receptive field enables the simultaneous aggregation of geometric context across both the full spatial dimensions and all synthesized view dimensions.

Further, this allows the GenFuSE method framework to intelligently resolve spatial occlusions and semantic conflicts from different camera angles, resulting in significantly improved voxel predictions, higher structural fidelity, and reduced 3D spatial uncertainty in complex real-world environments.

In other words, at a high level, the multi-view fusion adaptor (MVFA) can act as a type of intelligent decision maker that merges multiple 3D predictions (some of which may conflict) of a room into one perfectly accurate map.

For example, the original camera might not be able see a nightstand hidden behind a bed, but a synthesized virtual camera placed at a different angle can see the nightstand. To resolve this, the MVFA can take the 3D data from all these different camera viewpoints, divide it up into smaller chunks, and flatten it into sequences of data. Then, the MVFA can attach types of digital tags (positional encodings) to each piece of data so the system always knows exactly where in the room that piece belongs and which camera it came from.

Further in this example, once the data is organized and tagged, the MVFA feeds it into a powerful transformer AI model. This transformer uses a global self-attention mechanism to look at the entire space and all camera angles simultaneously. It mathematically cross-references the conflicting views (e.g., weighing the clear data from the virtual camera against the blocked view from the original camera) and prioritizes the most reliable information.

In this way, the MVFA can seamlessly fill in blind spots, resolve physical conflicts and output a single, highly detailed 3D map of the entire environment.

According to embodiments, the GenFuSE model can be trained in various ways. For example, prior to training the framework, input images from training datasets can undergo a preprocessing pipeline. The images can be normalized to ensure consistent data distribution.

Further, because certain generative modules within the framework may require specific input dimensions, the original input images can be resized, cropped or padded. While this preprocessing can result in some initial spatial information loss at the edges of the scene, the framework is designed to recover this peripheral context during the novel view synthesis (NVS) phase.

During the training phase, the virtual multi-view generation pipeline and the multi-view fusion adaptor (MVFA) can be integrated into a baseline semantic scene completion (SSC) architecture. For example, the method can be agnostic to the SSC model, but embodiments are not limited thereto.

In addition, to optimize training efficiency and leverage previously learned feature extractions, various pre-trained models within the framework can be kept frozen (e.g., their weights are not updated). For instance, pre-trained 2D image encoders, depth estimation networks, and the generative NVS modules can be locked during this phase. However, embodiments are not limited thereto.

Then, the remaining specialized modules of the framework, such as the 3D decoder, depth refinement networks, and the transformer-based MVFA, can be actively trained.

According to an embodiment, these trainable components can be optimized using specific hyperparameters, such as a predetermined learning rate, and techniques like early stopping based on performance metrics to prevent overfitting. By employing this modular training approach, the framework can be seamlessly integrated with and improve upon various existing baseline SSC architectures.

Various experiments were carried out against related art models to evaluate the results for the GenFuSE method framework.

As shown in Table I below, the model according to embodiments outperforms other related-art methods.

TABLE I

| | | SC | SSC | | | | | | | | | | | | |
|---|---|---|---|---|---|---|---|---|---|---|---|---|---|---|---|
| Method | N | IoU | [symbol] mp | Ce [symbol] l | Floor | Wall | Window | Chair | Bed | So [symbol] | Table | TV | Fu [symbol] | Obj | mIoU |
| ISO [symbol] [7] | 1 | 4 [symbol] .3 | 88.9 | 11.8 | 93.3 | 14.1 | 14.2 | 16.9 | 48.2 | 39.0 | 17.8 | 20.1 | 32.6 | 16.6 | 29.5 |
| +GenFuSE | 3 | 46.3 | 90.0 | 9.8 | 92.8 | 13.8 | 13.7 | 17.6 | 48.6 | 39.7 | 17.6 | 24.7 | 33.4 | 17.2 | 29.9 |
| | | +2.2% | | | | | | | | | | | | | +1.4% |
| NDCScene* [8] | 1 | 42.5 | 88.7 | 11.3 | 93.4 | 11.8 | 13.7 | 15.4 | 48.5 | 36.3 | 16.8 | 21.9 | 29.2 | 12.3 | 28.2 |
| +GenFuSE | 3 | 43.7 | 88.8 | 8.7 | 93.4 | 12.2 | 13.3 | 14.7 | 48.6 | 38.5 | 16.7 | 22.8 | 29.2 | 14.8 | 28.5 |
| | | +2.8% | | | | | | | | | | | | | +1.1% |
| Mono [symbol] ene* [9] | 1 | 40.0 | 86.8 | 8.0 | 92.9 | 9.9 | 11.2 | 10.9 | 44.2 | 32.4 | 14.2 | 11.2 | 24.5 | 12.3 | 24.5 |
| +GenFuSE | 3 | 41.0 | 87.8 | 7. [symbol] | 93.5 | 10.8 | 10.7 | 12.7 | 46.6 | 34.7 | 13.3 | 15.7 | 24.5 | 12.9 | 25.7 |
| | | +2.5% | | | | | | | | | | | | | +4.9% |

[symbol]

indicates data missing or illegible when filed

With reference to Table I, a summary of example, non-limiting experimental results is shown, which illustrates experimental evaluation results demonstrating the performance advantages of integrating the GenFuSE framework with various baseline semantic scene completion (SSC) methods.

As shown in Table I, GenFuSE acts as a highly adaptable, model agnostic enhancement that consistently improves 3D scene reconstruction accuracy across different foundational computer vision architectures, including the ISO, NDCScene, and Monoscene models. By utilizing multi-view processing (N=3) compared to the standard single-view baselines (N=1), the framework significantly enhances both the prediction of physical geometry and the accuracy of semantic labeling.

For example, the system was evaluated using the scene completion (SC) intersection over union (IoU) metric. The integration of GenFuSE yielded a relative SC IoU improvement of +2.2% when applied to the ISO baseline, increasing the score from 45.3 to 46.3.

Similarly, the GenFuSE framework provided a +2.8% SC IoU improvement for NDCScene (increasing from 42.5 to 43.7) and a +2.5% improvement for Monoscene (increasing from 40.0 to 41.0). This demonstrate a core advantage of the GenFuSE method in which synthesizing virtual views and mathematically fusing them allows the system to much more accurately predict occupied versus empty physical space, particularly in heavily occluded or hidden regions of the room.

Further, the evaluation measured the semantic scene completion (SSC) mean intersection over union (mIoU), which evaluates the system's accuracy in assigning the correct semantic class labels (such as floor, wall, window, chair, bed, and television) to the reconstructed 3D volumes.

When augmented with GenFuSE, the ISO baseline saw its overall mIoU increase from 29.5 to 29.9 (a +1.4% relative improvement), while the NDCScene mIoU increased from 28.2 to 28.5 (+1.1%). Notably, the Monoscene architecture experienced a substantial mIoU increase from 24.5 to 25.7, representing a +4.9% relative improvement when utilizing the GenFuSE pipeline.

Advantageously, these evaluation results establish that the GenFuSE framework effectively mitigates the limitations of standard monocular 3D reconstruction. By generating geometrically constrained virtual camera poses and intelligently fusing their respective volumetric predictions via the global self-attention mechanisms of the multi-view fusion adaptor (MVFA), the system successfully resolves semantic conflicts and reconstructs hidden geometries.

According to an embodiment, Table II below, illustrates experimental results demonstrating a novelty-consistency tradeoff in the selection of novel views for semantic scene completion. The performance of the GenFuSE framework was evaluated on the ISO baseline, utilizing two synthesized novel views in addition to the single original input view, for a total of N=3 views.

TABLE II

| Method | # Views | View (θ) | IoU (SC) | mIoU (SSC) |
|---|---|---|---|---|
| ISO* [7] | 1 | [0°] | 45.3 | 29.5 |
| +GenFuSE | 3 | [0°, ±10°] | 44.8 | 29.3 |
| +GenFuSE | 3 | [0°, ±20°] | 46.3 | 29.9 |
| +GenFuSE | 3 | [0°, ±30°] | 42.3 | 27.2 |

Table II compares the scene completion (SC) intersection over union (IoU) and the semantic scene completion (SSC) mean intersection over union (mIoU) across a single input view and three-view configurations with varying angular offsets (0) for the synthesized viewpoints.

For example, when views were placed too close to the original viewpoint (e.g., at)±10°, the added informational novelty was minimal, and the resulting scene predictions slightly degraded compared to the single-view baseline, with SC IoU dropping from 45.3 to 44.8 and SSC mIoU falling from 29.5 to 29.3. For example, low-novelty views might not provide sufficient diverse context to outweigh the added complexity and potential minor errors introduced during the fusion process.

In contrast, increasing the angle to ±20° yielded an optimal sweet spot where the novelty of the information (e.g., new scene details from different angles) was substantial, yet the geometric and semantic consistency with the original viewpoint remained high. This balance resulted in the highest overall performance, with SC IoU rising to 46.3 and SSC mIoU increasing to 29.9, demonstrating a clear improvement over the 1-view baseline.

Further analysis showed that pushing the synthesized views to more extreme angles (e.g., ±30°) significantly increased the novelty of the viewpoints but came at a cost to overall consistency.

As shown in the final row of Table II, this resulted in a degradation of performance, with SC IoU dropping to 42.3 and SSC mIoU dropping to 27.2. This decline can be attributed to increased errors in the view synthesis model at such extreme angles, making it difficult for the multi-view fusion adaptor (MVFA) 610 to reconcile disparate and less accurate individual predictions.

Thus, the novelty-consistency tradeoff embodiment defines an operational window for selecting novel viewpoints in the system, in which they should be novel enough to provide new spatial and semantic context but consistent enough to enable robust and accurate semantic scene completion.

According to an embodiment, the selected angles for placing the virtual cameras can be approximately ±20 degrees relative to the original physical viewpoint, as this angular offset can optimally balance informational novelty with geometric consistency, though other angles or ranges can be utilized depending on the specific scene characteristics and generative model capabilities.

According to an embodiment, the computing device 100 can be configured to achieve improved three-dimensional semantic scene completion. The computing device 100 can be used in various types of different spatial analysis and autonomous navigation situations.

According to one or more embodiments of the present disclosure, the AI device 100 can solve one or more technological problems in the existing technology, such as implementing accurate three-dimensional (3D) semantic scene completion through a multi-view generative fusion framework that can provide enhanced spatial awareness and occlusion resolution, while also reducing hardware costs.

For example, embodiments of the present disclosure can address the deficiencies of the related art monocular 3D reconstruction techniques, which suffer from an inability to accurately resolve hidden structural geometries due to visual occlusions, high spatial uncertainty, and the prohibitive costs and physical constraints associated with relying on physical multi-sensor hardware arrays such as LiDAR or complex stereo-camera rigs.

For example, embodiments of the present disclosure can address the deficiencies of the related art data generation techniques, which suffer from prohibitive costs, security risks associated with third-party services, a lack of semantic diversity, and an inability to programmatically ensure the safety and linguistic quality of the resulting training data.

Also, according to an embodiment, the AI device 100 configured with the multi-view fusion pipeline method can be used in an autonomous vehicle, a mobile terminal, a robotic navigation system, an augmented or virtual reality (AR/VR) headset, a smart home appliance, etc.

For example, the AI device can be applied in a wide range of interactive applications including an augmented reality (AR) system, a virtual reality (VR) system, and a home robot. For example, according to an embodiment, the home robot can determine the physical geometry and semantic layout of a room, and based on this information, the robot can perform a more relevant navigating or helping action, such as executing complex path planning and collision avoidance that more accurately addresses the spatial realities of the user's environment.

For example, methods and systems disclosed herein have broad applicability across a wide range of industries and technical fields that utilize spatial computing, autonomous navigation, and three-dimensional (3D) scene reconstruction. The 3D semantic occupancy maps generated by the disclosed GenFuSE pipeline can be well suited for deployment on resource constrained edge devices where deploying bulky, expensive and power intensive multi-sensor arrays (e.g., LiDAR or complex stereo-camera rigs) is prohibitive or physically impractical.

Non-limiting examples of such applications include consumer electronics and smart home appliances, such as robotic vacuums, security cameras, smart televisions, and interactive displays. The disclosed embodiments can allow manufacturers of such devices to rapidly and cost effectively develop and deploy advanced spatial awareness and room-mapping capabilities, utilizing low-cost 2D image sensors to accurately reconstruct even hidden or occluded geometries.

Further, the disclosed method can provide significant advantages for the automotive industry, where robust spatial understanding is desirable for driver safety and autonomous navigation. The trained models can be integrated into advanced driver-assistance systems (ADAS) or autonomous vehicle control systems to manage complex path planning, obstacle detection, and collision avoidance. The ability to mathematically fuse synthesized novel views allows for the creation of highly reliable vehicular systems that can accurately predict hidden structures and occluded objects (e.g., predicting the presence of a pedestrian stepping out from behind a parked vehicle) using a standard, monocular camera feed.

In an enterprise or industrial context, the method can be used to develop and deploy specialized autonomous agents for warehouse robotics, automated inventory management, real estate virtual tours, and architectural analysis. This enables companies to build powerful spatial mapping tools that construct complete, conflict-free 3D representations of complex, cluttered industrial environments from a single viewpoint, thereby streamlining operations and reducing hardware overhead.

Various aspects of the embodiments described herein can be implemented in a computer-readable medium using, for example, software, hardware, or some combination thereof. For example, the embodiments described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

Furthermore, although some aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, Python, PHP, HTML, or other programming languages. One or more of such software sections or modules can be integrated into a computer system, computer-readable media, or existing communications software.

Although the present disclosure has been described in detail with reference to the representative embodiments, it will be apparent that a person having ordinary skill in the art can carry out various deformations and modifications for the embodiments described as above within the scope without departing from the present disclosure. Therefore, the scope of the present disclosure should not be limited to the aforementioned embodiments, and should be determined by all deformations or modifications derived from the following claims and the equivalent thereof.

What is claimed is:

1. A method for controlling an artificial intelligence (AI) device, the method comprising:
receiving, by a processor in the AI device, a single two-dimensional (2D) image of a scene captured from an initial viewpoint;
determining, by the processor, a plurality of virtual camera poses spherically distributed around a centroid of the scene at predetermined angular offsets relative to the initial viewpoint;
generating, by a novel view synthesis model, a plurality of synthesized 2D images corresponding to the plurality of virtual camera poses;
processing, by a semantic scene completion model, the single 2D image and the plurality of synthesized 2D images to generate a plurality of corresponding three-dimensional (3D) scene predictions; and
fusing, by a transformer-based multi-view fusion adaptor, the plurality of corresponding 3D scene predictions to generate a unified 3D semantic occupancy map,
wherein the fusing includes applying a self-attention mechanism utilizing spatial positional encoding and view positional encoding to resolve structural ambiguities in one or more occluded regions of the scene.

2. The method of claim 1, further comprising:
determining a mean-depth of the scene from the single 2D image using a monocular depth estimator neural network,
wherein the centroid of the scene is calculated based on the mean-depth.

3. The method of claim 1, wherein the determining the plurality of virtual camera poses includes:
calculating a relative pose transformation based on the predetermined angular offsets; and
multiplying the relative pose transformation by an extrinsic camera matrix corresponding to the initial viewpoint.

4. The method of claim 1, wherein the predetermined angular offsets are approximately ±20 degrees relative to the initial viewpoint to optimize a tradeoff between informational novelty and geometric consistency.

5. The method of claim 1, wherein the processing by the semantic scene completion model includes:
extracting 2D features from the single 2D image and the plurality of synthesized 2D images; and
geometrically projecting the 2D features into 3D volumetric spaces to output the plurality of corresponding 3D scene predictions as multi-channel class-probability voxel grids.

6. The method of claim 1, wherein the plurality of corresponding 3D scene predictions include 3D voxel grids, respectively, and
wherein the fusing the plurality of corresponding 3D scene predictions includes:
partitioning the 3D voxel grids into a plurality of 3D voxel patches; and
flattening the plurality of 3D voxel patches into a sequence of one-dimensional (1D) tokens prior to applying the spatial positional encoding and the view positional encoding.

7. The method of claim 6, further comprising applying a linear transformation layer to the sequence of 1D tokens to project semantic channel probabilities into a higher-dimensional embedding space prior to applying the spatial positional encoding and the view positional encoding.

8. The method of claim 7, further comprising concatenating the sequence of 1D tokens corresponding to the initial viewpoint and the plurality of virtual camera poses into a single multi-view tensor to enable simultaneous global self-attention processing across all viewpoints.

9. The method of claim 6, wherein the applying the spatial positional encoding and the view positional encoding includes:
performing an element-wise addition of a spatial coordinate representation and a camera viewpoint identifier to the sequence of 1D tokens to generate encoded embeddings.

10. The method of claim 1, wherein the applying the self-attention mechanism includes:
computing queries, keys, and values from an embedded representation of the plurality of corresponding 3D scene predictions using learned weight matrices; and
calculating attention scores by applying a softmax function to dot products of the queries and the keys.

11. The method of claim 10, wherein the self-attention mechanism is executed by a multi-head transformer encoder, and
wherein the fusing further includes:
concatenating outputs from multiple attention heads of the multi-head transformer encoder to generate concatenated outputs; and
processing the concatenated outputs through a feed forward network includes fully connected linear layers separated by a non-linear activation function.

12. The method of claim 11, wherein the fusing further includes applying a residual connection that bypasses the self-attention mechanism and applying a layer normalization operation to generate the unified 3D semantic occupancy map.

13. An artificial intelligence (AI) device, comprising:
a memory configured to store information for information for a semantic scene completion model; and
a controller configured to:
receive a single two-dimensional (2D) image of a scene captured from an initial viewpoint,
determine a plurality of virtual camera poses spherically distributed around a centroid of the scene at predetermined angular offsets relative to the initial viewpoint,
generate, by a novel view synthesis model, a plurality of synthesized 2D images corresponding to the plurality of virtual camera poses,
process, by the semantic scene completion model, the single 2D image and the plurality of synthesized 2D images to generate a plurality of corresponding three-dimensional (3D) scene predictions, and
fuse, by a transformer-based multi-view fusion adaptor, the plurality of corresponding 3D scene predictions to generate a unified 3D semantic occupancy map,
wherein the transformer-based multi-view fusion adaptor is configured to apply a self-attention mechanism utilizing spatial positional encoding and view positional encoding to resolve structural ambiguities in one or more occluded regions of the scene.

14. The AI device of claim 13, wherein the controller is further configured to:
determine a mean-depth of the scene from the single 2D image using a monocular depth estimator neural network,
wherein the centroid of the scene is calculated based on the mean-depth.

15. The AI device of claim 13, wherein the controller is further configured to:
calculate a relative pose transformation based on the predetermined angular offsets and
multiply the relative pose transformation by an extrinsic camera matrix corresponding to the initial viewpoint.

16. The AI device of claim 13, wherein the predetermined angular offsets are approximately ±20 degrees relative to the initial viewpoint to optimize a tradeoff between informational novelty and geometric consistency.

17. The AI device of claim 13, wherein the semantic scene completion model is configured to:
extract 2D features from the single 2D image and the plurality of synthesized 2D images; and
geometrically project the 2D features into 3D volumetric spaces to output the plurality of corresponding 3D scene predictions as multi-channel class-probability voxel grids.

18. The AI device of claim 13, wherein the plurality of corresponding 3D scene predictions include 3D voxel grids, respectively, and
wherein the transformer-based multi-view fusion adaptor is configured to:
partition the 3D voxel grids into a plurality of 3D voxel patches, and
flatten the plurality of 3D voxel patches into a sequence of one-dimensional (1D) tokens.

19. The AI device of claim 13, wherein the transformer-based multi-view fusion adaptor is configured to:
compute queries, keys, and values from an embedded representation of the plurality of corresponding 3D scene predictions using learned weight matrices; and
calculate attention scores by applying a softmax function to dot products of the queries and the keys.

20. A non-transitory computer readable medium storing computer-executable instructions that when executed by a processor, cause the processor to perform the operations of:
receiving a single two-dimensional (2D) image of a scene captured from an initial viewpoint;
determining a plurality of virtual camera poses spherically distributed around a centroid of the scene at predetermined angular offsets relative to the initial viewpoint;
generating, by a novel view synthesis model, a plurality of synthesized 2D images corresponding to the plurality of virtual camera poses;
processing, by a semantic scene completion model, the single 2D image and the plurality of synthesized 2D images to generate a plurality of corresponding three-dimensional (3D) scene predictions; and
fusing, by a transformer-based multi-view fusion adaptor, the plurality of corresponding 3D scene predictions to generate a unified 3D semantic occupancy map,
wherein the fusing includes applying a self-attention mechanism utilizing spatial positional encoding and view positional encoding to resolve structural ambiguities in one or more occluded regions of the scene.
